(19) United States
(12) Patent Application Publication
(10) Pub. No.: US 2024/0073169 A1
(43) Pub. Date: Feb. 29, 2024

(54) A COMPUTER- IMPLEMENTED SYSTEM AND METHOD TO DEFINE HIDDEN FOLLOWERS AND HIDDEN COMMENTS IN A SOCIAL NETWORKING PORTAL

(71) Applicant: MALLIKARJUNARAO KODIDALA, Hyderabad (IN)

(72) Inventor: MALLIKARJUNARAO KODIDALA, Hyderabad (IN)

(21) Appl. No.: 18/273,352

(22) PCT Filed: Jan. 21, 2022
(86) PCT No.: PCT/IB2022/050551

§ 371 Date: Jul. 20, 2023

(30) Foreign Application Priority Data
Jan. 23, 2021 (IN) 202141003231

(51) Int. Cl. H04L 51/212; G06Q 50/00; H04L 51/52

(52) U.S. Cl. CPC H04L 51/212; G06Q 50/01; H04L 51/52

(57) ABSTRACT

A computer implemented system to define hidden followers and hidden comments on a social networking portal is disclosed. The system comprises instructions, when implemented on the portal to perform operations on the user's profiles, the operations include allowing the users to open follow others, or open comment others posts on the said social networking portal. The system is configured to store an ‘open’ or a ‘hidden’ follow request of other users, wherein the ‘hidden’ follow request is to be accepted by other users to follow each other in a ‘hidden mode’.

The present invention generally relates to social media. More particularly to a computer implemented system to define hidden followers and hidden comments on a social networking portal.

### BACKGROUND OF THE INVENTION

Many social media portals are there in the market. Most of the social media portals are providing same features. Many people are suffering with existing social portals.

Privacy and peace of mind are important while using the social media portals. In the existing social media portals privacy and peace of mind are missing by displaying all followers/following users' information to everyone in the world. Anybody can see a user's followers/following user information. All comments and replies are visible to everyone. Providing privacy to the social media users is the invention.

Privacy in Social Media

In the existing social media portals, a user's followers and following user information visible to everyone. Suppose if a user wants to hide some of the followers/following user information, it is not possible in the existing portals.

Many people in the world are bothering with trolling and bad comments for the posts/galleries which they make in the existing social media portals.

Many people's lives are disturbed due to these open accessibility of comments to everyone in the world. In the available social media either comments must be completely turned off or allow everyone to comment on their profiles. Comments can devolve into insults, threats, arguments, and harassment. The comments or posts posted in social media are available to any individual.

### BRIEF SUMMARY OF THE INVENTION

In the existing social media portals, there is no option to hide some of the followers as hidden. Either all followers are allowed to see others feed, gallery or comments, or completely hide the lists.

According to an aspect of the present invention, a computer implemented system to define hidden followers and hidden comments on a social networking portal is disclosed. The system comprises an electronic data storage configured to store social networking data of subscribed users of the social networking portal. The system comprises instructions, when implemented on the portal, causes operations on the user's profiles, the operations include allowing the users to open follow others, or open comment others posts on the said social networking portal.

In accordance with the aspect of the present invention, the said comments allowed by the said social networking portal include praise, ask a question, express disagreement, and otherwise contribute to the online conversation about the social content, and the comments can include text, hashtags, @ mentions, and emojis.

In accordance with the aspect of the present invention, the system is configured to store an ‘open’ or a ‘hidden’ follow request of other users, wherein the ‘hidden’ follow request is to be accepted by other users to follow each other in a ‘hidden mode’.

In accordance with the aspect of the present invention, the system is configured to provide permissions to users to comment on the posts, wherein the user can select the type of users to comment, in an ‘open’ and/or in a ‘hidden mode’.

In accordance with the aspect of the present invention, the system allows every social networking portal user to maintain two types of ‘followers’ namely ‘open’ and ‘hidden’ followers, wherein the ‘open’ followers are visible to everyone and the ‘hidden’ followers are not visible to anyone.

In accordance with the aspect of the present invention, the system while sending a follow request to other user, asks as the user wants to follow other user as ‘openly’ or ‘hiddenly’.

In accordance with the aspect of the present invention, the system allows other user to access a received follow request to take a decision whether to accept or reject the users request.

In accordance with the aspect of the present invention, the system allows to follow and become followers of a type (open or hidden), when both users accept same type of request.

In accordance with the aspect of the present invention, the system allows the users to follow each other based on the requests made by the users, if one user sends open follow request, and other user sends hidden follow request, both users can't become followers; either one of the users has to delete the request sent and send again a new request of the follow type which another user can accept.

In accordance with the aspect of the present invention, the system divides the comments into open and hidden comment sections, wherein open comments are visible to everyone, and hidden comments are visible only to the gallery owner and commenter.

In accordance with the aspect of the present invention, the system allows the user to choose which type of comment sections are required for each gallery while uploading a gallery (ex: open or hidden or both).

In accordance with the aspect of the present invention, the system allows the user to set permission while uploading a gallery, as who can comment on each comment section of the gallery, wherein with the restriction the approved user group can comment on it and it avoids bad comments and provide peace of mind to the users.

According to a second aspect of the present invention, a computer implemented method for hidden following and hidden commenting over a social networking portal explained. The method comprises a step of configuring an electronic data storage to store social networking data of subscribed users of the social networking portal. The method comprises another step of implementing instructions of the said system on the portal, to perform operations on the user's profiles, wherein the operations include allowing the users to follow others, or comment others posts on the said social networking portal.

In accordance with the second aspect of the present invention, the method comprises another step of allowing the users to give comments like a praise, ask a question, express disagreement, and otherwise contribute to the online conversation about the social content, including text, hashtags, @ mentions, and emojis.

In accordance with the second aspect of the present invention, the method comprises another step of allowing the users to configure the system to store an ‘open’ or a ‘hidden’ follow request of other users, wherein the ‘hidden’ follow request is to be accepted by other users to follow each other in a ‘hidden mode’.

In accordance with the second aspect of the present invention, the method comprises another step of allowing the users to tack the system to provide permissions to users to comment on the posts, wherein the user can select the type of users to comment, in an ‘open’ and/or in a ‘hidden mode’.

### BRIEF DESCRIPTION OF THE DRAWINGS

FIG. 1 illustrates a system where every user can maintain two types of followers in accordance with an exemplary embodiment of the present invention;

FIG. 2 illustrates how to make open following of users in accordance with an exemplary embodiment of the present invention;

FIG. 3 illustrates how to make hidden following in accordance with an exemplary embodiment of the present invention;

FIG. 4 illustrates hidden follow request and user 2 sends open follow request in accordance with an exemplary embodiment of the present invention;

FIG. 5 illustrates a user can choose which type of comment sections while uploading a gallery in accordance with an exemplary embodiment of the present invention;

FIG. 6 illustrates option of enabling open comments or hidden comments in accordance with an exemplary embodiment of the present invention;

FIG. 7 illustrates the systems component where a user can restrict who can comment in the comment section in accordance with an exemplary embodiment of the present invention.

### DETAILED DESCRIPTION OF INVENTION

In the existing social media platforms, if two users are following each other they were called followers or friends. In my approach there are two types of followers. Those two types of followers are Open followers and Hidden followers.

Instead of allowing all users to enter the comments, giving commenting access to a set of known audience will solve the problem. Creating two types of comment sections and giving permission to a set of users will solve the problem.

Completely turning off the comments section misses good comments, compliments from good people. So, we have come up with a new process of comments. where the user can decide who can comment. This feature makes the user to decide which comment or post can be made to public or to private audience.

Followers

Open Followers

If two users are following each other they are called followers. Some social media portals call them as followers. If another user sees these users' profile, that user can see that these two are following each other.

Every user can see other users' followers and following people. This is called open followers. Open followers are visible to all.

Referring to FIG. 2 in drawings shows how to make open following. Both users must send open follow request and both has to accept the request. Then they both become open followers for each other.

Hidden Followers

Hidden followers are visible only to the login user. Referring to FIG. 3 in drawings shows how to make open following.

Both users must send hidden follow request and both has to accept the request. Then they both become hidden followers for each other. While following a user to another user, providing two options will determine that you will be open friend or hidden friend.

Ex: User1 send open friend request to User 2, if User 2 likes that user, accepts that request, then they are called as open followers. If User2 doesn't like that person to be as open followers, User2 can delete that request and can send new follow type hidden request to User1.

If User1 accepts that request then they both are called as hidden followers.

Comments

In any social media, anyone can comment on other users posts or profile. Most of the people get bad comments by other users. Because users have to allow anyone to comment on it or completely disable the comments.

If the comments are categorised in to two types and provide permission to set of users (Open followers or Hidden Followers) then the reach of the comment or posts is limited and provide privacy. Because user is allowing to comment only a set of users.

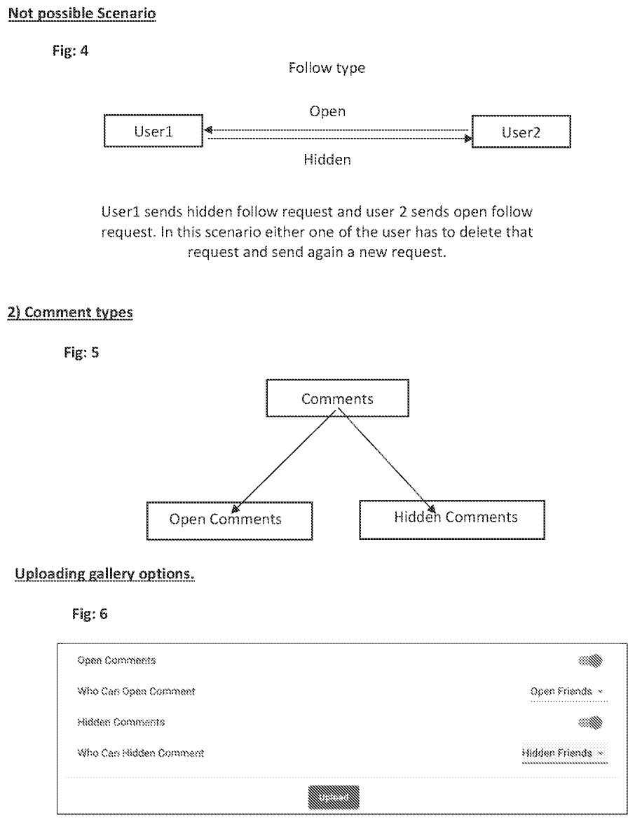

Comments are categorised in to two types. Those are open comments, and hidden comments, FIG. 5 in drawings.

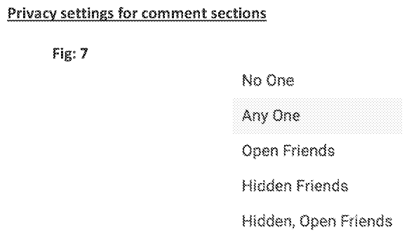

If users are divided in two categories, there are different combinations of comment settings are possible. Those possibilities are as in the FIG. 7 in drawings.
No One
Any One
Open friends/followers
Hidden friends/followers
Open and hidden friends/follower

Open Comments

In all existing social media portals only, open comments are there. Open comments are visible to everyone and anyone can comment on it. In my process comments can be restricted to set of users instead of allowing all users to enter on it.

Referring to FIG. 7 in drawings, while uploading a gallery a user can restrict who can comment on that comment section.

Hidden Comments

These comments are one to one. User who uploaded the picture can see all hidden comments of all users in a separate window which is not visible to others.

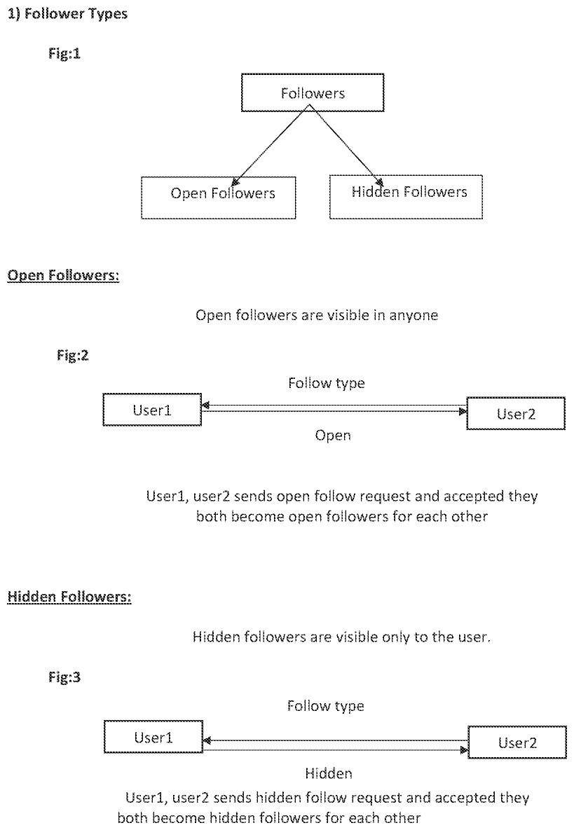

To solve the above problem, the inventors have come up with open and hidden follower's concept. Referring to FIG. 1 in drawings, every user can maintain two types of followers/following users. Those two types are open and hidden followers/following users. Open followers are visible to everyone, hidden followers are not visible to anyone.

In the existing social media portals, all the comments and replies are visible to Everyone. Celebrities and common people don't have privacy in the existing social media portals. All comments are visible to everybody. All followers/following users' information is visible to everyone.

When a celebrity likes one of his fan's social media pictures, that like information. visible to everybody. Then other fans may question him as why you didn't like my picture, am I not your fan?

Unknown people enter bad comments or replies on posts. Sometimes comments are toxic, users may feel mental disturbance. Current social media portals are allowing all people to enter the comments or completely turning off the comments section.

If a girl gets a bad comment in the existing social medial portals, she has to delete that bad comment and block that user. If she gives a strong reply to that bad comment, that reply is visible to everybody, then everyone judges her behaviour.

To solve that problem, I have come with open and hidden comment sections. Referring to FIG. 5 in drawings, while uploading a gallery a user can choose which type of comment sections and also user can set restrictions on comment sections as who can comment on those sections.

Referring to FIG. 6 while uploading a picture, providing option of enabling open comments or hidden comments sections with who can comment on those sections avoids bad and inappropriate comments.

I claim:

1. A computer implemented system to define hidden followers and hidden comments in a social networking portal, wherein the system comprises:
an electronic data storage configured to store social networking data of subscribed users of the social networking portal;
the system comprises instructions, when implemented on the portal, causes operations on the user's profiles, the operations include allowing the users to open follow others, or open comment others posts on the said social networking portal;
the said social networking portal allows the users comment on others posts, wherein the comments include praise, ask a question, express disagreement, and otherwise contribute to the online conversation about the social content, and the comments can include text, hashtags, @ mentions, and emojis;
Characterized in that
the system is configured to store an ‘open’ or a ‘hidden’ follow request of other users, wherein the ‘hidden’ follow request is by other users to follow each other in a ‘hidden mode’; and
the system is configured to provide permissions to users to comment on the posts, wherein the user can select the type of users to comment, in an ‘open’ and/or in a ‘hidden mode’.

2. The system as claimed in claim 1, wherein the system allows every social networking portal user to maintain two types of ‘followers’ namely ‘open’ and ‘hidden’ followers, wherein the ‘open’ followers are visible to everyone and the ‘hidden’ followers are not visible to anyone.

3. The system as claimed in claim 1, wherein the system while sending a follow request to other user, asks as the user wants to follow other user as ‘openly’ or ‘hiddenly’.

4. The system as claimed in claim 1, wherein the system allows other user to access a received follow request to take a decision whether to accept or reject the users request.

5. The system as claimed in claim 1, wherein the system allows to follow and become followers of a type (open or hidden), when both users accept same type of request.

6. The system as claimed in claim 1, wherein the system allows the users to follow each other based on the requests made by the users,
if one user sends open follow request, and other user sends hidden follow request, both users can't become followers;
Either one of the users has to delete the request sent and send again a new request of the follow type which another user can accept.

7. The system as claimed in claim 1, wherein the system divides the comments into open and hidden comment sections, wherein open comments are visible to everyone, and hidden comments are visible only to the gallery owner and commenter.

8. The system as claimed in claim 1, wherein the system allows the user to choose which type of comment sections are required for each gallery while uploading a gallery (ex: open or hidden or both).

9. The system as claimed in claim 1, wherein the system allows the user to set permission while uploading a gallery, as who can comment on each comment section of the gallery, wherein with the restriction the approved user group can comment on it and it avoids bad comments and provide peace of mind to the users.

10. A computer implemented method for open hidden following and open hidden commenting over a social networking portal, wherein the method comprises steps of:
configuring an electronic data storage to store social networking data of subscribed users of the social networking portal;
implementing instructions of the said system causes operations to perform on the user's profiles, wherein the operations include allowing the users to follow others, or comment others posts on the said social networking portal;
allowing the users to give comments like a praise, ask a question, express disagreement, and otherwise contribute to the online conversation about the social content, including text, hashtags, @ mentions, and emojis;
allowing the users to configure the system to store an ‘open’ or a ‘hidden’ follow request of other users, wherein the ‘hidden’ follow request is to be accepted by other users to follow each other in a ‘hidden mode’; and
allowing the users to provide permissions to users to comment on the posts, wherein the user can select the type of users to comment, in an ‘open’ and/or in a ‘hidden mode’.
